(19) United States
(12) Patent Application Publication
(10) Pub. No.: US 2012/0055628 A1
(43) Pub. Date: Mar. 8, 2012

(54) Doping apparatus for manufacturing electrode of energy storage device, and method for manufacturing electrode with the same

(75) Inventors: Hong Seok Min, Yongin-si (KR); Bae Kyun Kim, Seongnam-si (KR); Hyun Chul Jung, Yongin-si (KR); Dong Hyeok Choi, Suwon-si (KR); Hak Kwan Kim, Hanam-si (KR)

(73) Assignee: SAMSUNG ELECTRO-MECHANICS CO., LTD., Suwon (KR)

(21) Appl. No.: 13/137,502

(22) Filed: Aug. 22, 2011

(30) Foreign Application Priority Data
Aug. 27, 2010 (KR) 10-2010-0083383

(51) Int. Cl. B05D 5/12; B06B 1/20; B32B 38/00; B05D 3/14; B05C 13/00; B05C 3/152

(52) U.S. Cl. 156/278; 118/500; 118/419; 118/620; 118/221; 427/77; 427/601

(57) ABSTRACT

Disclosed herein is a doping apparatus for manufacturing an electrode of an energy storage device. The doping apparatus according to the exemplary embodiment of the present invention includes: a doping chamber body providing a doping space where a process of doping lithium ions onto an electrode plate is performed; a plurality of doping plates laminated vertically in the doping chamber body and containing lithium; and an electrode plate feeder feeding the electrode plate so that the electrode plate passes through gaps among the doping plates.

### CROSS REFERENCE TO RELATED APPLICATION

This application claims the benefit of Korean Patent Application No. 10-2010-0083383, filed on Aug. 27, 2010, entitled “Doping Apparatus For Manufacturing Electrode Of Energy Storage Device, And Method For Manufacturing Electrode With The Same”, which is hereby incorporated by reference in its entirety into this application.

### BACKGROUND OF THE INVENTION

1. Technical Field

The present invention relates to a doping apparatus for manufacturing an electrode of an energy storage device, and a method for manufacturing the electrode with the same, and more particularly, to a doping apparatus doping lithium ions onto an electrode plate for manufacturing a negative electrode and a method for manufacturing an electrode of a lithium ion capacitor by using the same in order to manufacturing a negative electrode of the lithium ion capacitor (LIC).

2. Description of the Related Art

A device called an ultra-capacitor and a super-capacitor among next-generation energy storage devices is in the spotlight as the next-generation energy storage device due to rapid charging/discharging speed, high stability, and environmentally friendly characteristic. The general super-capacitor includes an electrode structure, a separator, and an electrolyte solution. The super-capacitor is driven on the basis of as a principle an electro-chemical reaction mechanism selectively absorbing carrier ions in the electrolyte solution onto the electrode by applying electrical power to the electrode structure.

At present, as a representative super-capacitor, a lithium ion capacitor (LIC) is used. The general lithium ion capacitor includes an electrode structure having a positive electrode made of active carbon and a negative electrode made of various kinds of carbon materials (i.e., graphite, soft carbon, and hard carbon). A process of manufacturing the lithium ion capacitor includes an electrode manufacturing process of forming an electrode structure by repetitively laminating the positive electrode, the separator, and the negative electrode in sequence, a terminal welding process of welding plus and minus terminals to the electrode structure, and a lithium ion doping process of doping lithium ions (Li⁺) onto the negative electrode in advance.

In the known representative lithium doping process, a doping bath in which the electrolyte solution is filled is prepared and the electrode structure and a lithium containing doping plate disposed to face the electrode structure are disposed in the doping bath. In addition, by repetitively performing a charging process of applying voltage to the positive electrode and the negative electrode and a discharging process of applying voltage to the positive electrode and the lithium metal plate several times, the lithium ions in the doping plate are doped onto the negative electrode. However, in the lithium doping process, approximately 10 days or more are consumed until the lithium ions are evenly doped onto the negative electrode. Such a long lithium doping process serves as a principal factor to deteriorate the production efficiency of the general lithium ion capacitor.

### SUMMARY OF THE INVENTION

An object of the present invention is to provide a doping apparatus for effectively doping lithium ions onto an electrode of a lithium ion capacitor.

Another object of the present invention is to provide a lithium doping apparatus for shortening a doping process time to dope lithium ions onto an electrode of a lithium ion capacitor.

According to an exemplary embodiment of the present invention, there is provided a doping apparatus for an energy storage device, including: a doping chamber body providing a doping space where a process of doping lithium ions onto an electrode plate is performed; a plurality of doping plates laminated vertically in the doping chamber body and containing lithium; and an electrode plate feeder feeding the electrode plate so that the electrode plate passes through gaps among the doping plates.

The electrode plate feeder may feed the electrode plate so that the electrode plate moves from one opening to the other opening of any one gap of the gaps and thereafter, is bent and moves from other opening to one opening of another gap.

The electrode plate feeder may include: a first roller winding the electrode plate before the lithium doping process to standby; a second roller winding and recovering the electrode plate carried out from the doping chamber body while the lithium doping process is performed; and third rollers provided in the doping chamber body so that the electrode plate sequentially passes through all the gaps provided in a surface direction of the doping plate in the doping space.

The third rollers may be disposed at both sides of the doping chamber body and the third rollers disposed at one side of the doping chamber body may be disposed to have a zigzag structure with the third rollers disposed at the other side of the doping chamber body on the basis of the doping chamber body.

The doping apparatus may further include a heater heating the electrolyte solution so that the temperature of the electrolyte solution meets the temperature range of 20 to 70° C.

The electrolyte solution may contain at least one lithium-based electrolyte salt of LiPF6, LiBF4, LiSbF6, LiAsF5, LiClO4, LiN, CF3SO3, LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi.

The doping chamber may further include an electrolyte solution filled in the internal space and the doping apparatus may further include an ultrasonic provider applying ultrasonic waves to the electrolyte solution.

The doping apparatus may further include a drying chamber drying the electrode plate.

The drying chamber may include: a drying chamber body; fourth rollers disposed to have a zigzag structure in the drying chamber body; and a heater heating the electrode plate moved by the fourth rollers.

The doping apparatus may further include a driver driving the doping plates to contact the doping plates with the electrode plate in the doping chamber.

According to another exemplary embodiment of the present invention, there is provided a method for manufacturing an electrode, including: allowing an electrode plate to stand by; doping lithium ions onto the electrode plate by using doping plates containing the lithium ions; and recovering the electrode plate, wherein the allowing of the electrode plate to stand by, the doping of the lithium ions onto the electrode plate, and the recovering of the electrode plate are performed in-situ.

The allowing the electrode plate to stand by may include preparing a first roller wound with the electrode plate before the lithium doping process is performed and the recovering the electrode plate may include winding and recovering the electrode plate on a second roller after the lithium doping process is performed.

The doping the lithium ions onto the electrode plate may include: preparing a doping chamber body filled with an electrolyte solution; laminating the doping plates in the doping chamber body; and feeding the electrode plate so that the electrode plate passes through gaps among the doping plates.

The doping the lithium ions onto the electrode plate may include heating the electrolyte solution so that the temperature of the electrolyte solution meets the temperature range of 20 to 70° C.

The doping the lithium ions onto the electrode plate may further include applying ultrasonic waves to the electrolyte solution.

The electrolyte solution may contain at least one lithium-based electrolyte salt of LiPF6, LiBF4, LiSbF6, LiAsF5, LiClO4, LiN, CF3SO3, LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi.

The method may further include drying the electrode plate after the lithium doping process is performed.

The method may further include contacting the electrode plate and the doping plates with each other.

### BRIEF DESCRIPTION OF THE DRAWINGS

FIG. 1 is a diagram showing a lithium doping apparatus according to an exemplary embodiment of the preset invention;

FIG. 2 is a flowchart for describing an electrode manufacturing method using a doping apparatus according to an exemplary embodiment of the present invention; and

FIGS. 3 to 5 are diagrams for describing an electrode manufacturing process according to an exemplary embodiment of the present invention.

### DESCRIPTION OF THE PREFERRED EMBODIMENTS

Advantages and characteristics of the present invention, and a method for achieving them will be apparent with reference to embodiments described below in addition to the accompanying drawings. However, the present invention is not limited to the embodiments disclosed below, but may be implemented in various forms. The embodiments may be provided to completely disclose the present invention and allow those skilled in the art to completely know the scope of the present invention. Throughout the specification, like elements refer to like reference numerals.

Terms used in the specification are used to explain the embodiments and not to limit the present invention. In the specification, a singular type may also be used as a plural type unless stated specifically. “comprise” and/or “comprising” used the specification mentioned constituent members, steps, operations and/or elements do not exclude the existence or addition of one or more other components, steps, operations and/or elements.

Hereinafter, a lithium doping apparatus according to exemplary embodiments of the present invention will be described in detail with reference to the accompanying drawings.

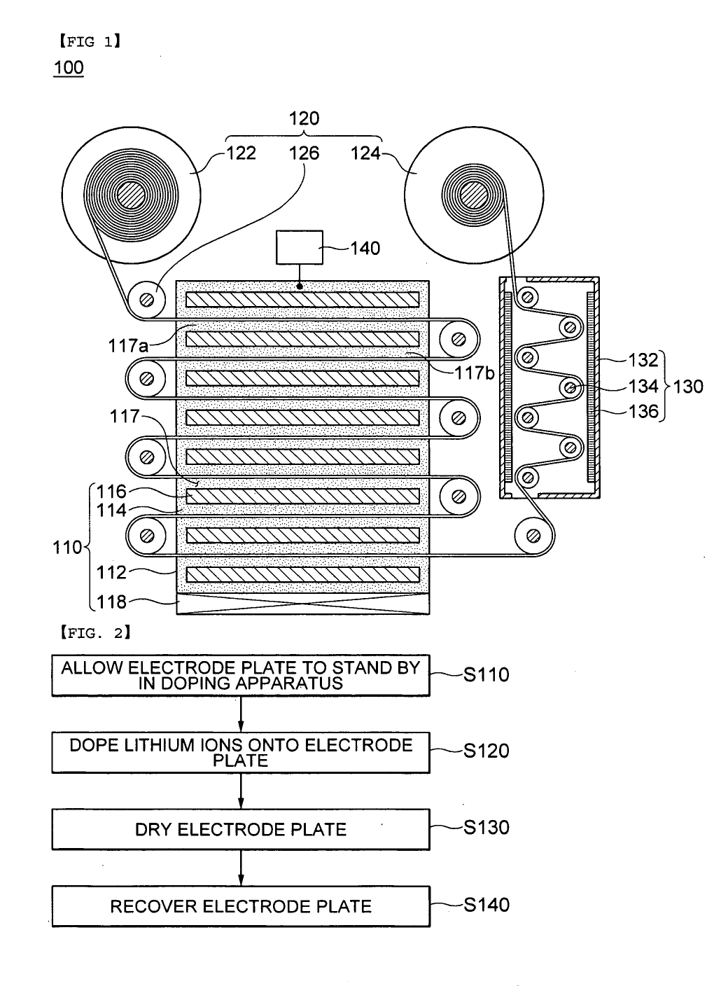

FIG. 1 is a diagram showing a lithium doping apparatus according to an exemplary embodiment of the preset invention. Referring to FIG. 1, the lithium doping apparatus 100 according to the exemplary embodiment of the present invention may include a doping chamber 110, an electrode plate feeder 120, a drying chamber 130, and an ultrasonic provider 140.

The doping chamber 110 may provide a process space where a lithium pre-doping process of doping lithium ions (Li⁺) onto an electrode plate 10 is performed. Herein, the electrode plate 10 may be a metal plate for manufacturing an electrode of an energy storage device so called an ultra-capacitor or a super-capacitor. For example, the electrode plate 10 may be a metal plate for manufacturing a negative electrode of a lithium ion capacitor (LIC).

The doping chamber 110 may include a doping chamber body 112, a doping plate 116, and a temperature controller 118.

The doping chamber body 112 may have an internal space where a process of doping lithium ions onto the electrode plate 10 is performed. The doping chamber body 112 may be used as a support for supporting components of the doping apparatus 100. Openings (not shown) for allowing the electrode plate 10 to enter and exit may be formed in the doping chamber body 112.

A predetermined electrolyte solution 114 may be filled in the internal space of the doping chamber body 112. The electrolyte solution 114 may be a composite prepared by dissolving electrolyte salt in which the lithium ions (Li⁺) are included in a predetermined solvent. Lithium-based electrolyte salt may be used as the electrolyte salt. The lithium-based electrolyte salt may include at least one of LiPF6, LiBF4, LiSbF6, LiAsF5, LiClO4, LiN, CF3SO3, and LiC. Alternately, the lithium-based electrolyte salt may include at least one of LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi. The electrolyte solution 114 may be used as a medium that moves the lithium ions from the doping plate 116 to the electrode plate 10.

The doping plate 116 may be a plate for doping the lithium ions onto the electrode plate 10. For example, the doping plate 116 may be a meal plate containing the lithium ions. The plurality of doping plates 116 may be disposed. In the case in which the plurality of doping plates 116 are provided, the doping plates 116 may be vertically laminated in the doping chamber body 112. Furthermore, the doping plates 116 may be separated from each other at regular intervals. As a result, the doping plates 116 may be configured so that a plurality of gaps 117 are formed between the doping plates 116. The gaps 117 may be provided in parallel to each other and have a structure in which the gaps are vertically laminated. The gaps 117 may be used as a movement path where the electrode plate 10 moves.

Meanwhile, it may be preferable that the gaps of the doping plates 116 are minimally controlled under a condition that the gaps do not prevent the electrode plate 10 from passing among the doping plates 116. This is because as the gaps between the electrode plate 10 and the doping plates 116 increase, doping efficiency of the lithium ions onto the electrode plate 10 may be deteriorated.

Alternately, the doping plates 116 may be disposed to be movable in the doping chamber 110 to contact the electrode plate 10 during the doping process. For example, the doping chamber 110 may further include a driver (not shown) moving the doping plates 116. The driver may drive the doping plates 116 so that two of the doping plates 116 contact both surfaces of the electrode plate 10 by accessing the electrode plate 10. For example, the driver is formed by combination of components such as a cylinder, an LM guide, and a driving motor to linearly move the doping plates 116.

The temperature controller 118 may control the temperature of the electrolyte solution 114 in the doping chamber body 112. The temperature controller 118 may include at least one heater. The temperature controller 118 may heat the doping chamber 110 so that the temperature of the electrolyte solution 114 meets a temperature range of approximately 20 to 70° C. As the temperature controller 118, at least one heater may be used. The heater may be provided at various positions of the doping chamber body 112 and may not be limited to the position shown in FIG. 1.

The electrode plate feeder 120 may feed the electrode plate 10 so that the electrode plate 10 passes through the gaps between the doping plates 116 in the doping chamber 110. For example, the electrode plate feeder 120 may have a roller structure including a plurality of rollers. For example, the electrode plate feeder 120 may include a first roller 122, a second roller 124, and a third roller 126.

The first roller 122 may allow the electrode plate 10 before the doping process to stand by. For this, the first roller 122 may be provided in the doping apparatus 100 while being wound with the electrode plate 10 before doping. Contrary to this, the second roller 124 may recover the electrode plate 10 which is subjected to the doping process. As a result, the first roller 122 may release the electrode plate 10 and the second roller 124 may wind and recover the electrode plate 10 which is released from the first roller 122.

The third roller 126 may guide the movement of the electrode plate 10 so that the electrode plate 10 released from the first roller 122 goes via the doping chamber 110 and is recovered to the second roller 124.

Meanwhile, the third roller 126 may be configured to increase the movement path of the electrode plate 10 in the doping chamber 110. Furthermore, the third roller 126 may be configured so that the electrode plate 10 passes through the gaps between the doping plates 116. For example, the plurality of third rollers 126 are provided on the side of the doping chamber 110. The third rollers 126 may be disposed to have a zigzag structure on the basis of the doping chamber 110. As a result, rollers disposed at one side of the doping chamber 110 among the third rollers 126 may be disposed in different heights as compared with rollers disposed at the other side of the doping chamber 110.

The electrode plate feeder 120 having such a structure may allow the electrode plate 10 to move in the doping chamber 110 while sequentially passing through the gaps 117 constituted by the doping plates 116. More specifically, the electrode plate feeder 120 may allow the electrode plate 10 to move from one opening 117a to the other opening 117b of any one gap 117 of the gaps 117 and thereafter, allow the electrode plate 10 to move from the other opening 117b to one opening 117a of the other gap 117 by being bent by the third roller 126. As a result, the electrode plate feeder 120 may have a structure in which a movement section of the electrode plate 10 which passes adjacent to the doping plates 116 increases in the doping chamber 110.

The drying chamber 130 may dry the electrode plate 10 which is subjected to the doping process. For example, the drying chamber 130 may include a drying chamber body 132, a fourth roller 134, and a heater 136. The drying chamber body 132 may have an internal space where a drying process of drying the electrode plate 10 is performed. The fourth roller 134 may be provided to increase the movement path of the electrode plate 10 in the drying chamber body 132. For this, the fourth roller 134 may be disposed in a zigzag structure in different heights in the drying chamber body 132. In addition, the heater 136 may heat the electrode plate 10 which is moved by the fourth roller 134 in the drying chamber body 132. As the heater 136, a heater or a heat blower may be used.

The ultrasonic provider 140 may be provided to increase the efficiency of the lithium ion doping process onto the electrode plate 10. For example, the ultrasonic provider 140 may apply a predetermined ultrasonic wave to the electrolyte solution 114 in the doping chamber 110. In this case, the efficiency of the lithium ion doping process onto the electrode plate 10 may be increased by the electrolyte solution 114 to which the ultrasonic wave is applied during the doping process. As another example, the ultrasonic provider 140 may be configured to apply the ultrasonic wave to the doping plate 116 or directly apply the ultrasonic wave to the electrode plate 10. A scheme in which the ultrasonic provider 140 applies the ultrasonic wave to the doping chamber 110 may be variously changed and modified in order to increase the doping process efficiency. Meanwhile, the intensity of the ultrasonic wave which the ultrasonic provider 140 applies to the electrolyte solution 114 may be changed depending on thicknesses of the electrode plate 10 and the doping plates 116 and a doping intensity onto the electrode plate 10.

As described above, the lithium doping apparatus 100 according to the exemplary embodiment of the present invention may include a doping chamber 110 having an internal space where the doping plates 116 are laminated and an electrode plate feeder 120 that moves the electrode plate 10 so as to sequentially go via the gaps 117 among the doping plates 116. Herein, the doping chamber 110 and the electrode plate feeder 120 may have a maximized structure a movement section of the electrode plate 10 where the electrode plate 10 moves among the gaps 117 and a doping time so that the doping process is performed onto the doping plates 116 in the doping chamber 110 for a maximum long time. As a result, a lithium doping apparatus according to the present invention may improve lithium doping process efficiency by increasing doping sections of the electrode plate 10 and the doping plates 110 per unit area.

Further, the lithium doping apparatus 100 according the exemplary embodiment of the present invention may consecutively and automatically perform a stand-by process of the electrode plate 10 before doping, a doping process, a drying process, and a recovery process. As a result, the lithium doping apparatus according to the present invention automates a lithium doping process in an in-line scheme to improve the lithium doping process efficiency and shorten a time for the lithium doping process.

Subsequently, an electrode manufacturing process using a doping apparatus for manufacturing an electrode of an energy storage device according to an exemplary embodiment of the present invention will be described in detail. Herein, a duplicated content of the doping apparatus 100 described with reference to FIG. 1 may be omitted or simplified.

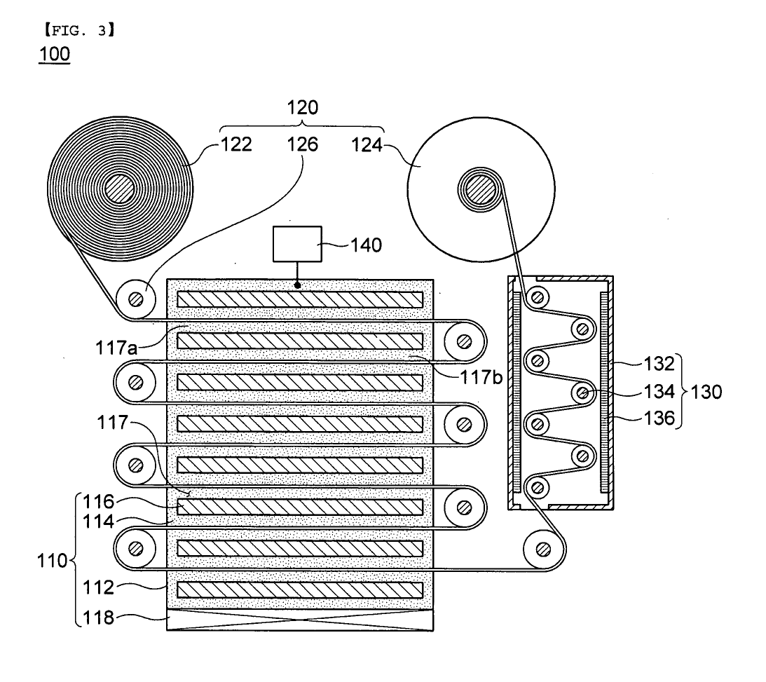

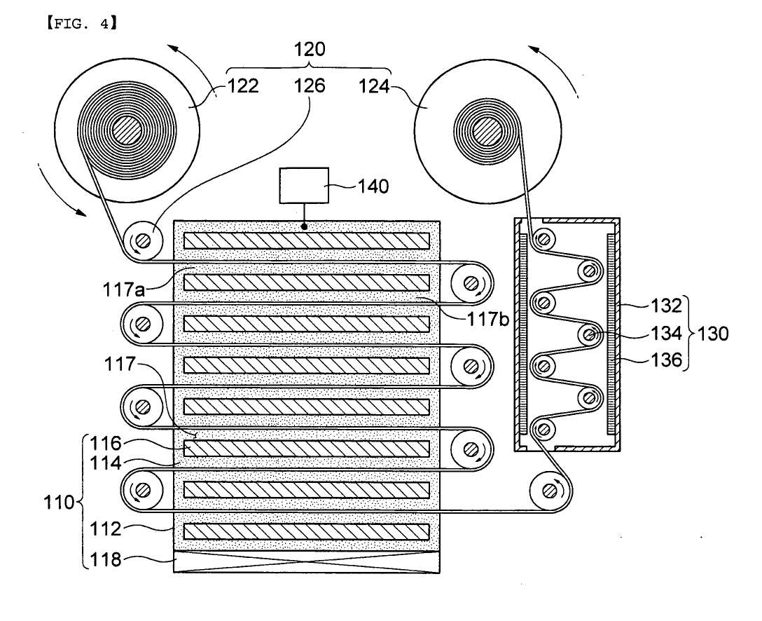

FIG. 2 is a flowchart for describing an electrode manufacturing method using a doping apparatus according to an exemplary embodiment of the present invention and FIGS. 3 to 5 are diagrams for describing an electrode manufacturing process according to an exemplary embodiment of the present invention.

The electrode manufacturing method of the energy storage device according to the exemplary embodiment of the present invention may be achieved by consecutively processing allowing an electrode plate to stand by, doping lithium ions onto the electrode plate, drying the electrode plate, and recovering the electrode plate in-situ by using the doping apparatus 100 described above with reference to FIG. 1. As a result, the electrode manufacturing method according to the exemplary embodiment of the present invention may automate the electrode plate stand-by process, the lithium ion doping process, the electrode plate drying process, and the electrode plate recovering process in an in-line scheme.

Hereinafter, each of the electrode plate stand-by process, the lithium ion doping process, the electrode plate drying process, and the electrode plate recovering process will be described in detail.

Referring to FIGS. 2 and 3, an electrode plate 10 may stand by in the doping apparatus 100 (S110). The allowing of the electrode plate 10 to stand by may include preparing the electrode plate 10 manufactured in a foil type, winding and storing the electrode plate 10 on a first roller 122, and mounting the first roller 122 wound with the electrode plate 10 on the doping apparatus 100.

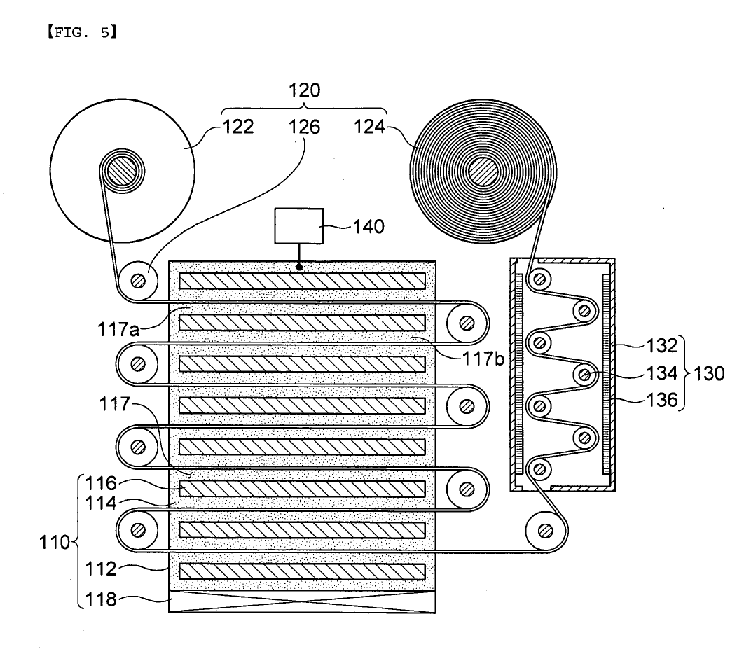

Referring to FIGS. 2 and 4, lithium ions may be doped onto the electrode plate 10 (S120). The doping of the lithium ions onto the electrode plate 10 may include preparing a doping chamber body 112 filled with an electrolyte solution 114, disposing a lamination structure of doping plates 116 containing the lithium ions in the doping chamber body 112, and feeding the electrode plate 10 so that the electrode plate 10 passes through gaps 117 among the doping plates 116 in sequence. The feeding of the electrode plate 10 may be performed by driving a roller structure constituted by first to third rollers 122, 124, and 126.

During the doping of the lithium ions onto the electrode plate 10, the process temperature of the electrolyte solution 114 may be controlled to meet the temperature range of approximately 20 to 70° C. For this, the temperature controller 118 may consistently heat the electrolyte solution 114 so that the temperature of the electrolyte solution 114 meets the temperature process.

Further, during the doping of the lithium ions onto the electrode plate 10, applying ultrasonic waves to the electrolyte solution 114 may further be added. The applying of the ultrasonic waves may be added in order to increase the doping efficiency of the lithium ions onto the electrode plate 10.

Meanwhile, the doping of the lithium ions onto the electrode plate 10 may further include contacting the electrode plate 10 and the doping plates 116 with each other. The contacting of the electrode plate 10 and the doping plates 116 may include stopping the movement of the electrode plate 10 and moving the doping plates 116 so that the doping plates 116 move toward the electrode plate 10. The moving of the doping plates 116 may be performed by allowing two doping plates 116 to form one pair and contact both surfaces of the electrode plate 10, respectively. In this case, the doping efficiency of the lithium ions onto the electrode plate 10 may be increased.

Referring to FIGS. 2 and 5, the electrode plate 10 may be dried (S130). For example, after doping the lithium ions, the electrode plate 10 carried out from the doping chamber body 112 may be wetted by the electrolyte solution 114. As a result, a process of removing the electrolyte solution 114 that remains on the electrode plate 10 may be performed. For this, the drying of the electrode plate 10 may be performed by heating the electrode plate 10 with a predetermined heater or applying a hot wind with a heat blower.

In addition, the electrode plate 10 which is subjected to the lithium doping process may be recovered (S140). In the process of recovering the electrode plate 10, the drying-completed electrode plate 10 may be stored while being wound on the second roller 124. Herein, when the entire electrode plate 10 wound on the first roller 122 is wound on the second roller 124, the second roller 124 may be removed from the doping apparatus 100 and moved to a location where a post-process for electrode manufacturing is performed.

As described above, the electrode manufacturing method according to the exemplary embodiment of the present invention may be performed by consecutively processing the allowing of the electrode plate 10 to stand by, the doping of the lithium ions onto the electrode plate 10, the drying of the electrode plate 10, and the recovering of the electrode plate 10 in-situ. As a result, the electrode manufacturing method according to the present invention automates and processes an electrode plate stand-by process, a lithium ion doping process, an electrode drying process, and an electrode plate recovery process in one doping apparatus 100 in an in-line scheme to shorten an electrode manufacturing process time of an energy storage device and improve a yield.

According to the present invention, a doping apparatus for manufacturing an electrode of an energy storage device includes a doping chamber having an internal space where doping plates are laminated and an electrode plate feeder feeding an electrode plate to sequentially go via gaps among the doping plates, wherein the doping chamber and the electrode plate feeder may have a structure to maximize a movement distance of the electrode plate in which the electrode plate moves through the gaps and a doping time. As a result, a lithium doping apparatus according to the present invention can improve lithium doping process efficiency by increasing doping sections of the electrode plate and the doping plates per unit area.

The doping apparatus according to the present invention can consecutively and automatically perform a stand-by process of the electrode plate before doping, a doping process, a drying process, and a recovery process. As a result, the lithium doping apparatus according to the present invention automates a lithium doping process in an in-line scheme to improve the lithium doping process efficiency and shorten a time for the lithium doping process.

An electrode manufacturing method according to an exemplary embodiment of the present invention automates an electrode plate stand-by process, a lithium ion doping process, an electrode drying process, and an electrode plate recovery process in one doping apparatus in an in-line scheme to shorten an electrode manufacturing process time of an energy storage device and improve a yield.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

The above detailed description exemplifies the present invention. Further, the above contents just illustrate and describe preferred embodiments of the present invention and the present invention can be used under various combinations, changes, and environments. That is, it will be appreciated by those skilled in the art that substitutions, modifications and changes may be made in these embodiments without departing from the principles and spirit of the general inventive concept, the scope of which is defined in the appended claims and their equivalents. Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Therefore, the detailed description of the present invention does not intend to limit the present invention to the disclosed embodiments. Further, it should be appreciated that the appended claims include even another embodiment.

What is claimed is:

1. A doping apparatus for manufacturing an electrode of an energy storage device, comprising:
a doping chamber body providing a doping space where a process of doping lithium ions onto an electrode plate is performed;
a plurality of doping plates laminated vertically in the doping chamber body and containing lithium; and
an electrode plate feeder feeding the electrode plate so that the electrode plate passes through gaps among the doping plates.

2. The apparatus according to claim 1, wherein the electrode plate feeder feeds the electrode plate so that the electrode plate moves from one opening to the other opening of any one gap of the gaps and thereafter, is bent and moves from other opening to one opening of another gap.

3. The apparatus according to claim 1, wherein the electrode plate feeder includes:
a first roller winding the electrode plate before the lithium doping process to standby;
a second roller winding and recovering the electrode plate carried out from the doping chamber body while the lithium doping process is performed; and
third rollers provided in the doping chamber body so that the electrode plate sequentially passes through all the gaps provided in a surface direction of the doping plate in the doping space.

4. The apparatus according to claim 3, wherein the third rollers are disposed at both sides of the doping chamber body, and
the third rollers disposed at one side of the doping chamber body are disposed to have a zigzag structure with the third rollers disposed at the other side of the doping chamber body on the basis of the doping chamber body.

5. The apparatus according to claim 1, further comprising a heater heating the electrolyte solution so that the temperature of the electrolyte solution meets the temperature range of 20 to 70° C.

6. The apparatus according to claim 1, wherein the doping chamber further includes an electrolyte solution filled in the internal space, and
the electrolyte solution contains at least one lithium-based electrolyte salt of LiPF6, LiBF4, LiSbF6, LiAsF5, LiClO4, LiN, CF3SO3, LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi.

7. The apparatus according to claim 1, wherein the doping chamber further includes an electrolyte solution filled in the internal space, and
the doping apparatus further includes an ultrasonic provider applying ultrasonic waves to the electrolyte solution.

8. The apparatus according to claim 1, further comprising a drying chamber drying the electrode plate.

9. The apparatus according to claim 8, wherein the drying chamber includes:
a drying chamber body;
fourth rollers disposed to have a zigzag structure in the drying chamber body; and
a heater heating the electrode plate moved by the fourth rollers.

10. The apparatus according to claim 1, further comprising a driver driving the doping plates to contact the doping plates with the electrode plate in the doping chamber.

11. A method for manufacturing an electrode of an energy storage device, comprising:
allowing an electrode plate to stand by;
doping lithium ions onto the electrode plate by using doping plates containing the lithium ions; and
recovering the electrode plate,
wherein the allowing the electrode plate to stand by, the doping the lithium ions onto the electrode plate, and the recovering the electrode plate are performed in-situ.

12. The method according to claim 11, wherein the allowing the electrode plate to stand by includes preparing a first roller wound with the electrode plate before the lithium doping process is performed, and
the recovering the electrode plate includes winding and recovering the electrode plate on a second roller after the lithium doping process is performed.

13. The method according to claim 11, wherein the doping the lithium ions onto the electrode plate includes:
preparing a doping chamber body filled with an electrolyte solution;
laminating the doping plates in the doping chamber body; and
feeding the electrode plate so that the electrode plate passes through gaps among the doping plates.

14. The method according to claim 11, wherein the doping the lithium ions onto the electrode plate includes heating the electrolyte solution so that the temperature of the electrolyte solution meets the temperature range of 20 to 70° C.

15. The method according to claim 11, wherein the doping the lithium ions onto the electrode plate further includes applying ultrasonic waves to the electrolyte solution.

16. The method according to claim 11, wherein the electrolyte solution contains at least one lithium-based electrolyte salt of LiPF6, LiBF4, LiSbF6, LiAsF5, LiClO4, LiN, CF3SO3, LiN(SO2CF3)2, LiN(SO2C2F5)2, LiC(SO2CF3)2, LiPF4(CF3)2, LiPF3(C2F5)3, LiPF3(CF3)3, LiPF5(iso-C3F7)3, LiPF5(iso-C3F7), (CF2)2(SO2)2NLi, and (CF2)3(SO2)2NLi.

17. The method according to claim 11, further comprising drying the electrode plate after the lithium doping process is performed.

18. The method according to claim 11, further comprising contacting the electrode plate and the doping plates with each other.
